(19) United States
(12) Patent Application Publication
(10) Pub. No.: US 2004/0168620 A1
(43) Pub. Date: Sep. 2, 2004

(54) Underground vault security system

(76) Inventors: Steven A. Vitale, Staten Island, NY (US); Michael J. McEnerney, College Point, NY (US); Albert W. Gershman, Matawan, NJ (US); Anthony L. Schwab, Staten Island, NY (US)

Correspondence Address: DICKSTEIN SHAPIRO MORIN & OSHINSKY LLP, 2101 L STREET NW, WASHINGTON, DC, 20037-1526, US

(21) Appl. No.: 10/373,779

(22) Filed: Feb. 27, 2003

(51) Int. Cl. E05G 1/00

(52) U.S. Cl. 109/1 S

(57) ABSTRACT

An underground vault security system. The security system includes a portal covering which is capable of being latched, a fluid-operated latching mechanism, and a wireless communication device. The communication device sends signals to a solenoid valve to allow fluid from a fluid source to be transported to the piston to retract the bolt and allow the portal covering to open. In one embodiment, the communication device also sends signals to the solenoid valve to allow fluid from the piston to return to the fluid source, allowing the bolt to extend into and lock the portal covering. In another embodiment, a cable is attached to the bolt and pulled through a one-way ratchet assembly to lock the portal covering.

### FIELD OF THE INVENTION

The invention generally relates to underground vaults, and more particularly to a system and apparatus for enhancing the security of underground vaults.

### BACKGROUND

Underground vaults that are accessible via manhole covers are known to be used in several industries. For example, telephone companies often run telephone lines underground and provide switching stations within underground vaults. Further, water companies and other suppliers of fluidic media, such as, for example, natural gas companies, often transport fluidic media via a collection of underground piping. The underground vaults utilized by the fluidic media transporters house regulators which step down the pressure at which the fluidic media is transported. Conventionally known underground vaults are generally fabricated from concrete or steel, are accessible via a manhole cover or Bilco® door, and are generally square or rectangular in shape. The manhole covers or Bilco® doors provide personnel access to the underground vaults. In the case of underground vaults that house regulators, personnel can gain access to the underground vaults to maintain the gas regulators or to enact repairs to or replacement of the regulators.

As noted above, conventional underground vaults generally are accessed via portal coverings such as manhole covers or Bilco® doors. One disadvantage with conventional underground vaults is the easy accessibility afforded by these portal coverings. Specifically, anyone, including unauthorized personnel, can gain access to underground vaults easily by merely opening the portal coverings.

Of particular concern is that the collection of piping, in the case of a natural gas or water regulator underground vault, or the collection of telephone lines could be sabotaged or otherwise tampered with. There is thus a desire to provide enhanced security to underground vaults.

### SUMMARY

The invention provides a security system for an underground vault. The security system includes a portal covering for providing accessibility to an enclosed space, a latching mechanism, and a wireless communication device adapted to send signals for operating said latching mechanism.

The invention also provides an underground vault that includes a portal covering, an enclosed vault structure accessible through said portal covering, a fluid-operated latching mechanism for providing accessibility through said portal covering, and a wireless communication device capable of transmitting signals to said fluid-operated latching mechanism.

The invention further provides a method for securing an underground vault. The method includes the steps of providing an external portal covering for enclosing the underground vault, providing an internal portal covering inside the external portal covering, providing a latching mechanism adapted to selectively lock and unlock the internal portal covering, and providing a wireless communication device adapted to communicate signals to the latching mechanism.

These and other advantages and features of the invention will be more readily understood from the following detailed description of the invention that is provided in connection with the accompanying drawings.

### BRIEF DESCRIPTION OF THE DRAWINGS

FIG. 1 illustrates a schematic view of an underground vault constructed in accordance with an embodiment of the invention.

FIG. 2 illustrates another schematic view of underground vault of FIG. 1 showing the inner hatch in an open position.

FIG. 3 is a cross-sectional view taken along line III-III of FIG. 1.

FIG. 4 is a perspective view of the latching mechanism of FIG. 1.

FIG. 5 is a schematic representation of the movement of the bolt of FIG. 1.

FIG. 6 illustrates a schematic view of an underground vault constructed in accordance with an embodiment of the invention.

FIG. 7 illustrates another schematic view of underground vault of FIG. 6 showing the inner hatch in an open position.

FIG. 8 is a schematic view of a latching mechanism used in the underground vault of FIG. 6.

FIG. 9 is a partial cross-sectional view of the latch of the latching mechanism of FIG. 8.

FIG. 10 is a partial cross-sectional view of a latch of the latching mechanism constructed in accordance with an embodiment of the invention.

FIG. 11 illustrates a schematic view of an underground vault constructed in accordance with another embodiment of the invention.

FIG. 12 is a perspective view of the latching mechanism of FIG. 11.

FIG. 13 is a perspective view of the gripper mechanism of FIG. 11.

FIG. 14 is a view of the pan of FIG. 11.

### DETAILED DESCRIPTION OF PREFERRED EMBODIMENTS

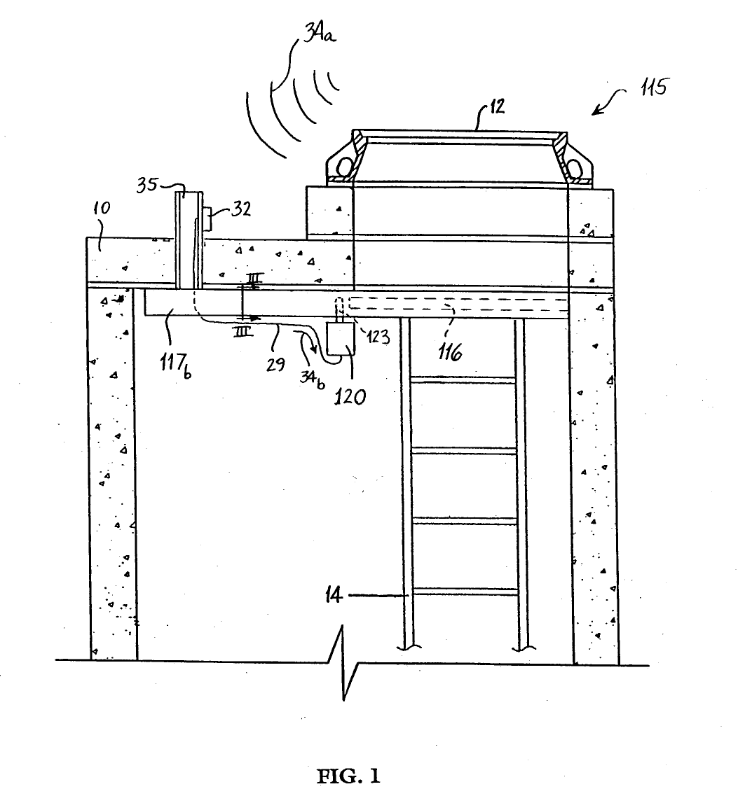

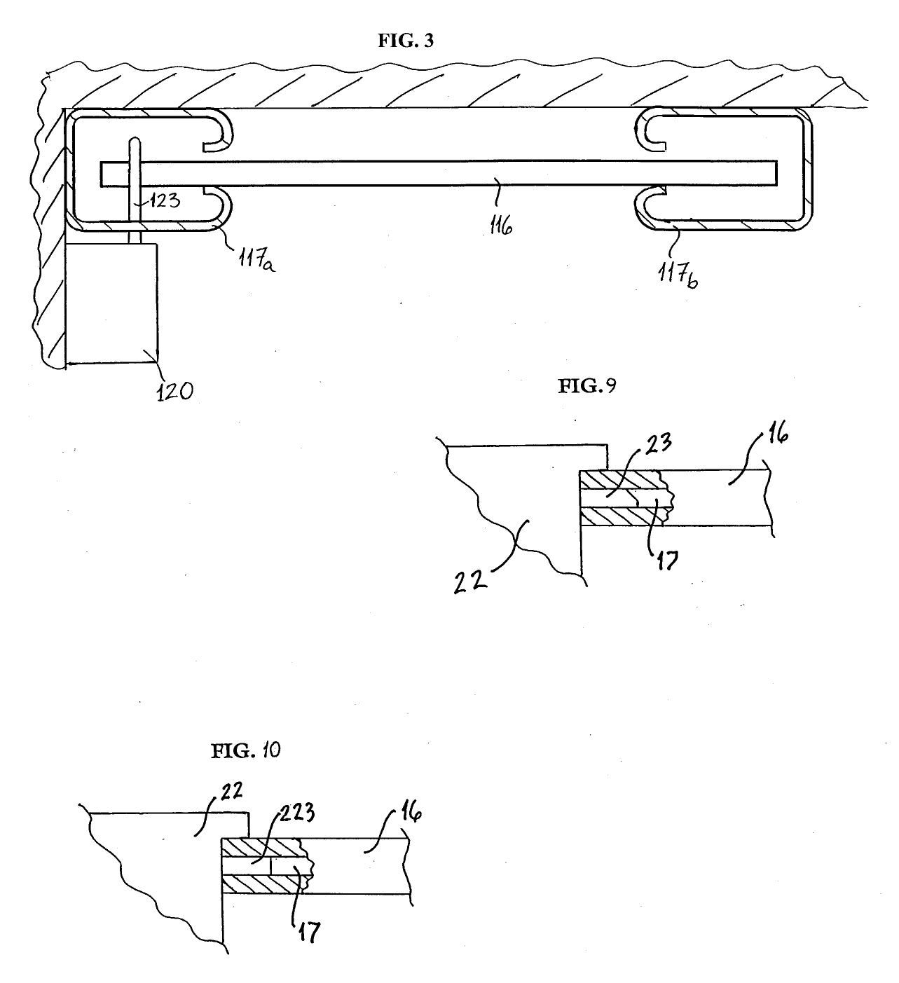

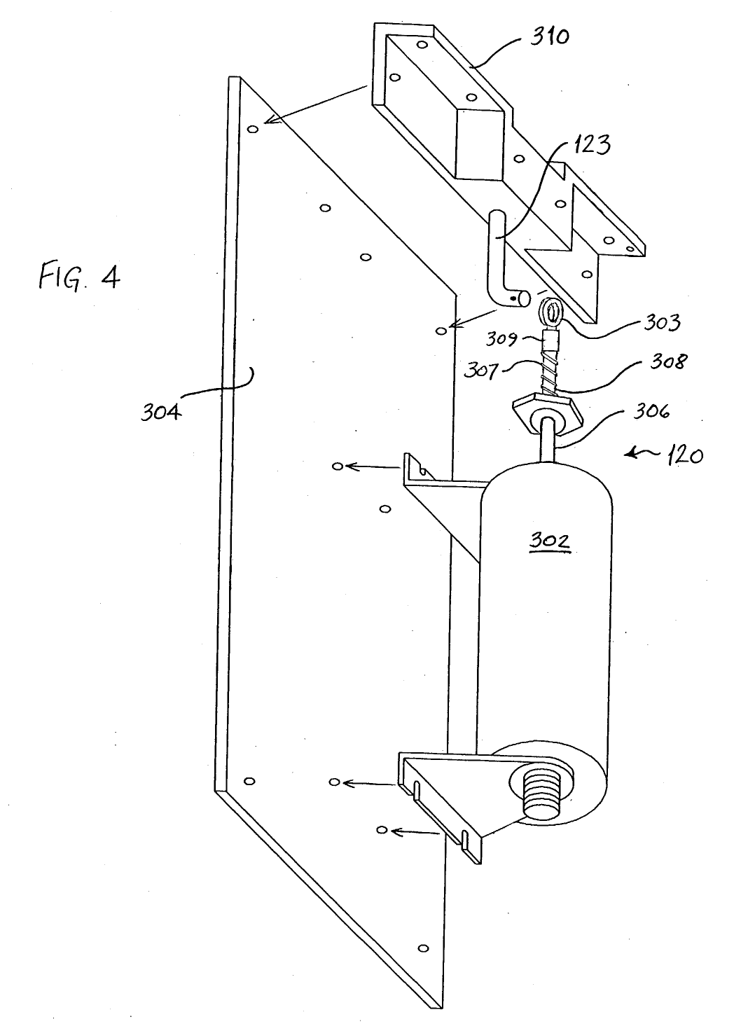

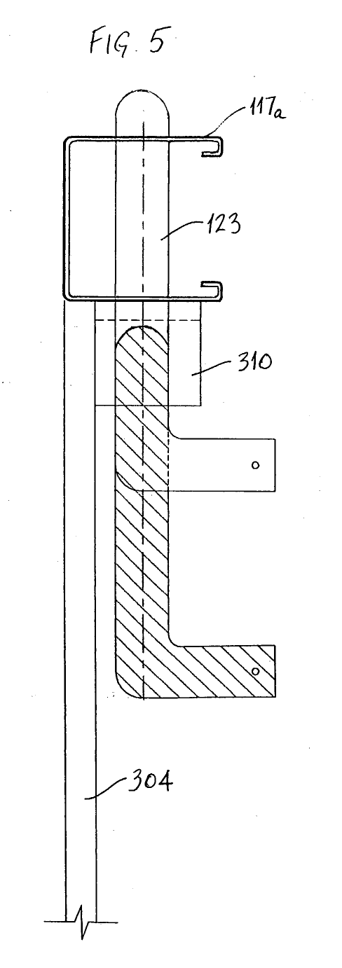

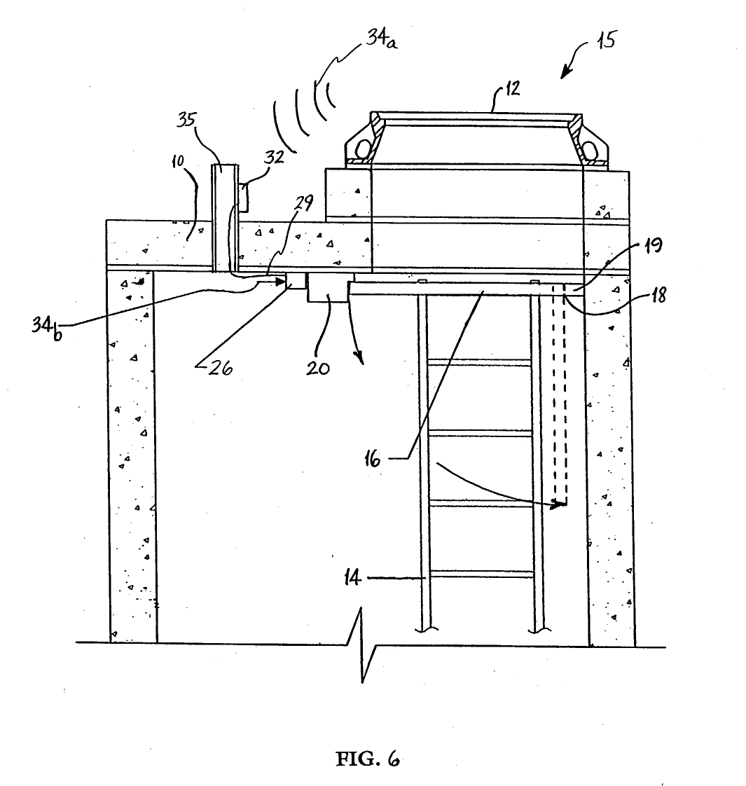

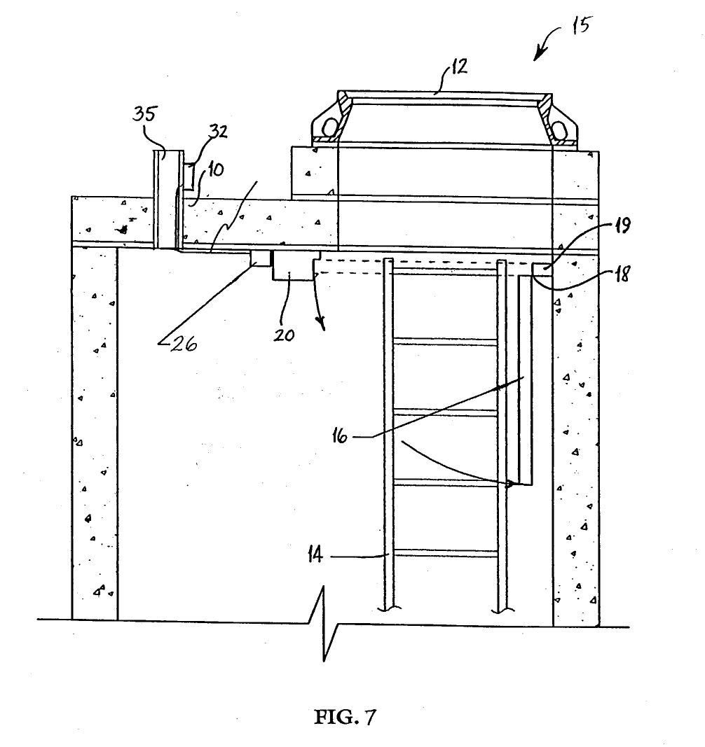

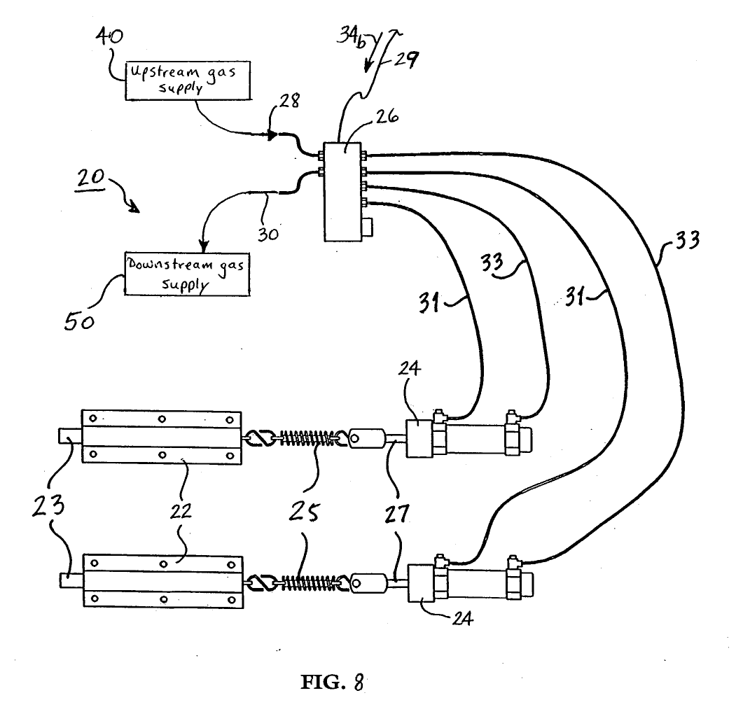

With specific reference to FIGS. 1-5, there is shown an underground vault 115 including a vault structure 10, an outer portal covering 12, and an inner portal covering 116. As illustrated, the outer portal covering 12 is a manhole cover, but it should be understood that any suitable portal covering, such as, for example, a Bilco® door, may be used. A ladder 14 extends from the opening of the vault 10 toward a base (not shown) of the vault.

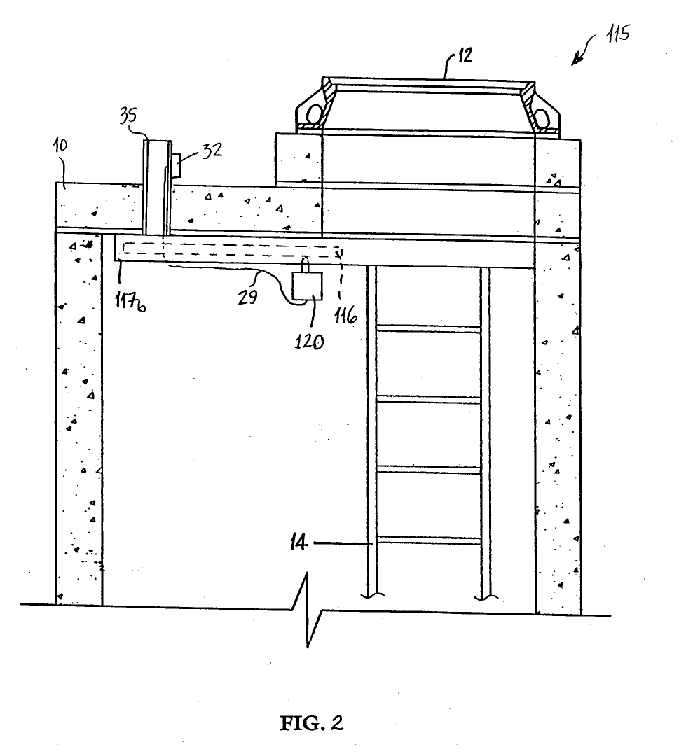

The inner portal covering 116 is shown in FIG. 1 in the closed position and is shown in the open position in FIG. 2. The inner portal covering 116 is locked into the closed position with a latching mechanism 120. The inner portal covering 116 is positioned in a pair of C-frames 117a, 117b so as to be able to slide from a closed position to an open position.

A latching mechanism 120 (shown schematically in FIGS. 1-3 and in detail in FIGS. 4 and 5) includes a bolt 123. The bolt 123 has a rounded end and is preferably spring-biased in the extended position, although it need not be. The C-frame 117a includes an orifice to allow the bolt 123 to extend through the C-frame 117a and inhibit movement of the inner portal covering 116. With specific reference to FIGS. 4 and 5, the latching mechanism includes a gas cylinder 302 mounted on a base plate 304. The base plate 304 is itself mounted on a wall of the vault 10. Further included in the latching mechanism 120 is a mounting bracket 310 through which the bolt 123 extends. A rod end 306 extends from the gas cylinder 302. The rod end 306 is connected with a bushing 308, around which is positioned a spring 307. A collar 303 is connected to the bushing 308 through a brace 309. The collar 303 fits over a bent end of the bolt 123. A nut or other device may be used to retain the collar 303 over the bolt 123. The spring 307 provides a force against the brace 309, thereby extending the bolt 123. The gas pressure from the gas cylinder 302 retracts the bolt 123. Retraction of the bolt 123, which in its protruded position inhibits sliding movement of the inner portal covering 116, allows the inner portal covering 116 to be moved to an open position, allowing entry into the vault 10.

A signal transmission line 29 extends from the latching mechanism 120 to a control mechanism 32. The transmission line 29, as shown in FIGS. 1 and 2, runs out of the vault 10 through a vent shaft 35, upon which the control mechanism 32 is mounted. The control mechanism 32 may be a radio transceiver capable of receiving wirelessly transmitted signals and transmitting signals via the transmission line 29. Specifically, and as illustrated in FIG. 1, wirelessly transmitted signals 34a are received by the control mechanism 32, which then transmits signals 34b through transmission line 29 to the latching mechanism 120 to signal the retraction of the bolt 123. Particularly, and as described in greater detail below, the gas activated piston of the latching mechanism 120 is in fluid communication with gas. To retract the bolt 123, the transmitted signals 34b signal the solenoid valve to open a valve and allow the gas cylinder 302 to be pressurized. The pressurized gas is used to retract the bolt 123, allowing the inner portal covering 116 to become unlocked and to be manually slid open.

Referring to FIGS. 6-9, there is shown an underground vault 15 constructed in accordance with another embodiment of the invention. The underground vault 15 includes the vault structure 10, the outer portal covering 12, and an inner portal covering 16. The inner portal covering 16 is shown in FIG. 6 in the closed position and is shown in the open position in FIG. 7. The inner portal covering 16 is locked into the closed position with a latching mechanism 20. The inner portal covering 16 is pivotably attached to a base 19 with hinges 18. Although a hinged inner portal covering 16 is shown, it should be understood that any form of portal impediment may be used, including, for example, a roll door or a Bilco® door.

Next, with reference to FIGS. 8 and 9, will be described the latching mechanism 20, which as shown includes a pair of latches 22, a pair of springs 25 and a pair of gas activated piston mechanisms 24 each connected with a three-way solenoid valve 26. Each of the latches 22 includes a bolt 23, and each of the gas activated piston mechanisms 24 includes a piston 24 connected to a respective spring 25. Each spring 25 connects at the other end with and provides a biasing force on a respective bolt 23. It should be appreciated, however, that the latching mechanism 20 may instead include only a single latch 22, spring 25 and gas activated piston mechanism 24.

Fluidic media, such as, for example, natural gas, is generally transported at a high pressure, somewhere on the order of about sixty pounds per square inch (psi). At periodic locations, it is necessary to step down the pressure of the natural gas, such as at locations where gas is shunted over to individual customer use. At such locations, the gas pressure must be stepped down to a lower pressure, on the order of about one-fourth psi. In underground vaults 10 housing regulators for natural gas, the regulators monitor the stepped down pressure to suppress any deviation in the downstream gas pressure. In such an underground vault 10, natural gas is used to power the gas activated piston mechanisms 24. The natural gas may be siphoned from the upstream gas pipeline, thus obviating the requirement of a compressor or an additional supply of gas. In underground vaults 10 that house regulators for water pipelines or are used for other purposes, a supply of water, an additional gas supply, or another energy source may be used to activate the pistons 27.

In the closed (locked) position, no gas is siphoned off from an upstream gas supply 40 to the gas activated piston mechanisms 24 and the bolts 23 are extended into bore holes 17 of the inner portal covering 16. The springs 25 exert a biasing force on the bolts 23 in the extended position. The illustrated bolts 23 have a chamfered end, while bolts 223 (FIG. 10) do not have a chamfered end. To unlock the inner portal covering 16 and put it in the open position, gas is siphoned off from the upstream gas supply 40, traveling through inlet conduit 28 through the three-way solenoid valve 26 to the piston mechanisms 24 via tubing 31. The siphoned gas causes the pistons 27 to retract, allowing the inner portal covering 16 to become unlocked and to swing open.

To then lock the inner portal covering 16, the covering 16 is moved into the closed position and the siphoned gas is vented through tubing 33 and through the three-way solenoid valve 26 to an outlet conduit 30 which leads to a downstream gas supply 50. In this way, the inner portal covering 16 can be opened and closed using a pneumatic device. Further, since the pressure of the natural gas being transported in the pipelines is being stepped down, energy is conserved by utilizing energy released from the gas taken from the upstream gas supply 40 and then shunting the gas to the downstream gas supply 50. An additional benefit is that no natural gas is vented to the atmosphere.

Next will be described a communication system for communicating signals to the three-way solenoid valve 26. In order to access the underground vault 10, one must be able to unlock the inner portal covering 116, 16 from the outside. The latching mechanism 120, 20 is operated through mechanisms within the underground vault and not accessible from outside the vault, and thus a communication system including the control mechanism 32 in FIGS. 1, 2, 6, 7 may be used to send signals to the three-way solenoid valve 26. The control mechanism 32 communicates with a pager, personal computer, mobile phone, or other similar personal communication device via wirelessly transmitted signals 34a. Specifically, an authorized person can page the control mechanism 32 with a signal 34a authorizing opening of the inner portal covering 116, 16. The control mechanism 32 receives the signals 34a and then transmits signals 34b via the transmission line 29 to the three-way solenoid valve 26. The solenoid valve 26 siphons off gas from the upstream gas supply 40 to the gas activated piston mechanisms 24, thereby enabling the retraction of the bolts 123, 23 and the opening of the inner portal covering 116, 16.

If a spring, such as spring 307 (FIG. 4) or 25 (FIG. 8) are used to bias the bolts 123, 23 in the extended position, then no signals will be necessary to cause extension of the bolts 123, 23. Instead, the action of the spring 25 will be sufficient to ensure the bolts 123, 23 extend to their original extended position. Alternatively, in the event the spring 25 is not included in the latching mechanism 120, 20, the authorized person can send another signal 34a via pager or other suitable wireless communication device to the control mechanism 32 authorizing closing of the inner portal covering 16. The control mechanism 32 transmits a signal 34b via transmission line 29 to the three-way solenoid valve 26, enabling the gas within the gas activated piston mechanisms 24 to be vented to the downstream gas supply 50 via the tubing 33 and the outlet conduit 30, enabling the bolts 123, 23 to return to their original extended position.

As described above, the outer portal covering 12, the inner portal covering 116, 16, the latching mechanism 120, 20 and the control mechanism 32 combine to create an enclosure system that is suitable for enclosing an underground vault 10. It should be appreciated that the enclosure system also may be suitable for limiting access to any enclosed structure which is to be accessible only for selective personnel.

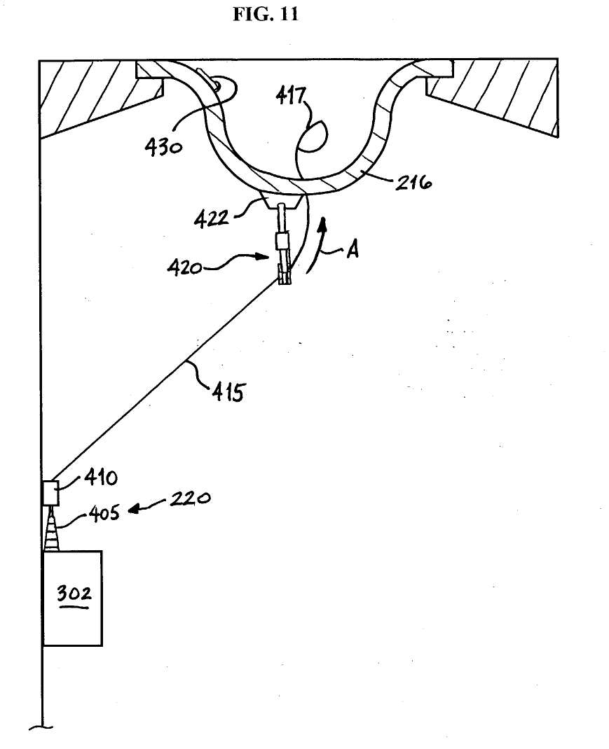

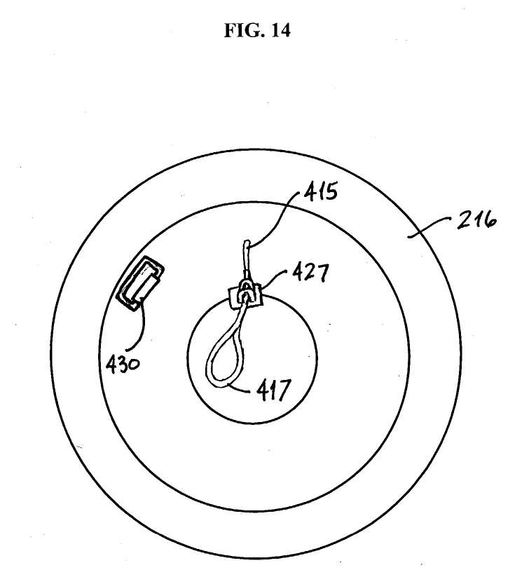

Next, with reference to FIGS. 11-14, will be described another embodiment of the invention. An inner portal covering, specifically a circular pan 216, is shown in FIGS. 11 and 14. A cable 415 extends through a hole in an upper surface of the pan 216 down to a latching mechanism 220. The cable 415 is threaded through a gripper mechanism 420 anchored on an underside of the pan 216 with an anchor 422.

The gripper mechanism 420 includes a one-way ratchet assembly 425 that allows the cable 415 to freely move in the direction of arrow A (FIG. 11) but prevents any movement in a direction opposite arrow A unless disengaged. The cable 415 is threaded through a clasp 417 and ends with an upper loop 417 for enabling one to pull the cable 415 in the direction of arrow A. A handle 430 is provided on an upper surface of the pan 216 to enable one to remove the pan 216 when unlocked.

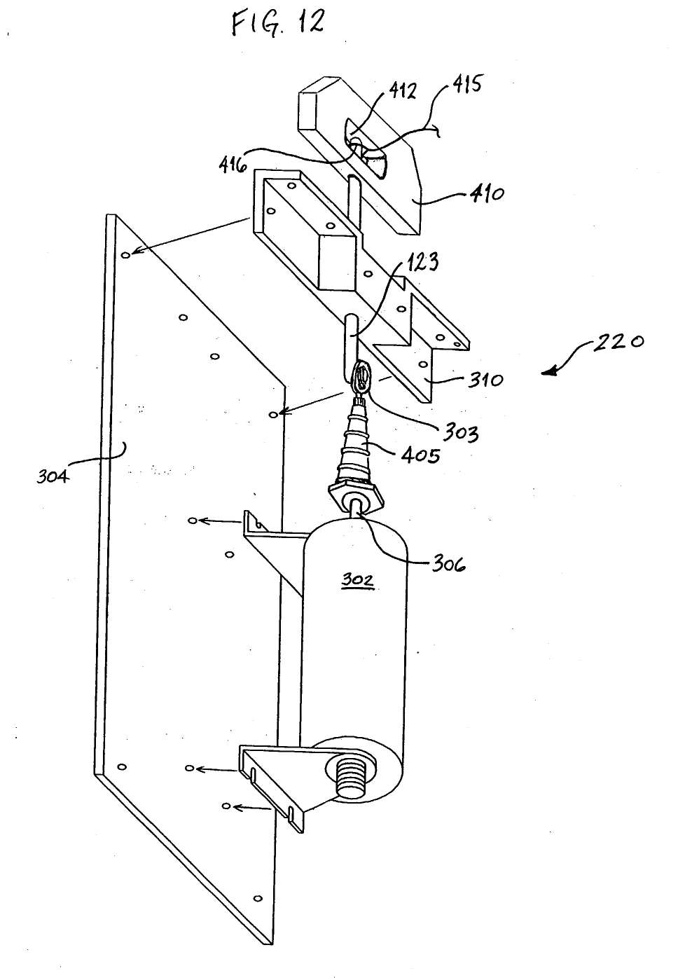

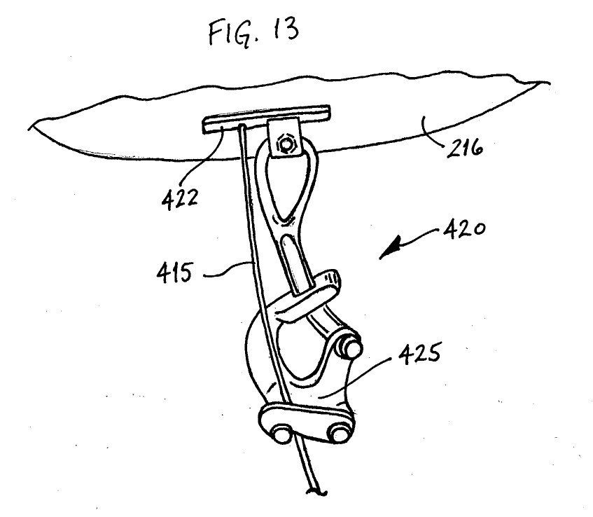

The latching mechanism 220, which is mounted to a fixed point on a wall of the vault, is similar to the latching mechanism 120 (FIGS. 1-5) except that it includes a nosepiece 410. The nosepiece 410 includes an opening 412 as well as a pair of holes sized and shaped to receive the bolt 123. The cable 415 also includes a lower loop 416 (FIG. 12) which is sized to fit around the bolt 123 within the opening 412. A boot 405 is shown covering the spring 307, bushing 308, and brace 309. The boot 405 functions to suppress environmental conditions from causing deleterious effects on the spring 307, bushing 308 and brace 309, as well as to suppress the entry of contaminants into the gas cylinder 302.

In operation, the spring 307 serves to extend the bolt 123 through the mounting bracket 310 and the holes of the nosepiece 410. The lower loop 416 of the cable 415 is fit over the bolt 123 as it extends through the opening 412. With the lower end of the cable 415 now anchored to the latching mechanism 220, an authorized person can place the pan 216 in position and pull on the cable 415, using the upper loop 417. As the cable 415 is pulled, the one-way ratchet assembly 425 prevents the cable 415 from moving in a direction other than the direction of arrow A. Once the cable 415 is taut, the pan 216 is locked in position, and the extra cable 415 can be coiled up within the pan 216. Then, the outer portal covering 12 can be replaced. To unlock the pan 216, as in the previously described embodiments, wirelessly transmitted signals 34a are received by the control mechanism 32, which then transmits signals 34b through the transmission line 29 to the latching mechanism 220 to signal the retraction of the bolt 123. Specifically, the transmitted signals 34b signal the solenoid valve to allow the cylinder to be pressurized. The pressurized gas retracts the bolt 123, allowing the pan 216 to be unlocked and lifted out of place by the handle 430.

While the invention has been described in detail in connection with exemplary embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, while two latching mechanisms 20 and two gas activated piston mechanisms 24 are shown and described, it should be appreciated that in certain embodiments a single latching mechanism 20 and a single gas activated piston mechanism 24, or greater than two latching mechanisms 20 and gas activated piston mechanisms 24, may be used. Accordingly, the invention is not to be seen as limited by the foregoing description, but is only limited by the scope of the appended claims.

What is claimed as new and desired to be protected by Letters Patent of the United States is:

1. A security system for an underground vault, comprising:
a portal covering for providing accessibility to an enclosed space;
a latching mechanism; and
a wireless communication device adapted to send signals for operating said latching mechanism.

2. The security system of claim 1, wherein said latching mechanism comprises a fluid-operated latching mechanism comprising:
a fluid-operable piston mechanism;
a rod end connected on one end to said fluid-operable piston mechanism;
a bushing connected to said rod end, a spring surrounding said bushing;
a retractable bolt adapted to being moved by said spring; and
a valve in fluid communication with said fluid-operable piston mechanism.

3. The security system of claim 2, wherein said valve comprises a three-way solenoid valve.

4. The security system of claim 2, wherein said fluid-operable piston mechanism comprises a gas cylinder mounted on a base plate.

5. The security system of claim 2, wherein said fluid-operated mechanism further comprises a nosepiece which is configured to receive said retractable bolt.

6. The security system of claim 5, further comprising a one-way ratchet attached to said portal covering and a cable threaded through said one-way ratchet and connectable with said retractable bolt.

7. The security system of claim 1, wherein said latching mechanism comprises a fluid-operated latching mechanism including a fluid-operable piston mechanism and wherein first and second tubes extend between said valve and said fluid-operable piston mechanism, said first tube being adapted to transport a fluid at a first pressure to said fluid-operable piston mechanism from said valve and said second tube being adapted to transport a fluid at a second pressure from said fluid-operable piston mechanism to said valve, said first pressure being greater than said second pressure.

8. The security system of claim 7, wherein said fluid-operable piston mechanism comprises a gas piston mechanism and said fluid comprises gas.

9. The security system of claim 8, wherein said gas transported in said first tube activates said gas piston mechanism and provides a pulling force on said spring, said pulling force being translated to said retractable bolt to retract said retractable bolt from said portal covering.

10. An underground vault, comprising:
a portal covering;
an enclosed vault structure accessible through said portal covering;
a fluid-operated latching mechanism for providing accessibility through said portal covering; and
a wireless communication device capable of transmitting signals to said fluid-operated latching mechanism.

11. The underground vault of claim 10, wherein said fluid-operated latching mechanism comprises:
a fluid-operable piston mechanism;
a rod end connected on one end to said fluid-operable piston mechanism;
a bushing connected to said rod end, a spring surrounding said bushing;
a retractable bolt adapted to being moved by said spring; and
a valve in fluid communication with said fluid-operable piston mechanism.

12. The underground vault of claim 11, wherein said valve comprises a three-way solenoid valve.

13. The underground vault of claim 11, wherein said fluid-operable piston mechanism comprises a gas cylinder mounted on a base plate.

14. The underground vault of claim 11, wherein said fluid-operated mechanism further comprises a nosepiece which is configured to receive said retractable bolt.

15. The underground vault of claim 14, further comprising a one-way ratchet attached to said portal covering and a cable threaded through said one-way ratchet and connectable with said retractable bolt.

16. The underground vault of claim 10, wherein said fluid-operated latching mechanism comprises a fluid-operable piston mechanism and wherein first and second tubes extend between said valve and said fluid-operable piston mechanism, said first tube being adapted to transport a fluid at a first pressure to said fluid-operable piston mechanism from said valve and said second tube being adapted to transport a fluid at a second pressure from said fluid-operable piston mechanism to said valve, said first pressure being greater than said second pressure.

17. The underground vault of claim 16, wherein said fluid-operable piston mechanism comprises a gas piston mechanism and said fluid comprises gas.

18. The underground vault of claim 17, wherein said gas transported in said first tube activates said gas piston mechanism and provides a pulling force on said spring, said pulling force being translated to said retractable bolt to retract said retractable bolt from said portal covering.

19. The underground vault of claim 10, wherein said portal covering comprises a hatch.

20. The underground vault of claim 10, wherein said portal covering comprises a Bilco® door.

21. The underground vault of claim 10, wherein said portal covering comprises a circular pan.

22. The underground vault of claim 10, further comprising a second portal covering, said portal covering being positioned between said second portal covering and said vault structure.

23. A method for securing an underground vault, comprising:
providing an external portal covering for enclosing the underground vault;
providing an internal portal covering inside said external portal covering;
providing a latching mechanism adapted to selectively lock and unlock said internal portal covering; and
providing a wireless communication device adapted to communicate signals to said latching mechanism.

24. The method of claim 23, wherein said providing a latching mechanism comprises:
providing a fluid-operable piston mechanism;
connecting a bushing through a rod end to said fluid-operable piston mechanism;
surrounding said bushing with a spring;
providing a retractable bolt being movable by said spring; and
providing a valve in fluid communication with said fluid-operable piston mechanism.

25. The method of claim 24, wherein said connecting step further comprises connecting said bushing to said retractable bolt through a collar to enable said bushing to move said retractable bolt.

26. The method of claim 24, further comprising providing a nosepiece configured to receive said retractable bolt.

27. The method of claim 26, further comprising providing a one-way ratchet attached to said internal portal covering and a cable threaded through said one-way ratchet and connectable with said retractable bolt.

28. The method of claim 27, wherein steps for locking said internal portal covering comprise:
connecting said cable to said retractable bolt;
extending said retractable bolt into said nosepiece to prevent said cable from disconnecting from said retractable bolt; and
pulling on said cable from outside the underground vault until taut, wherein said one-way ratchet prevents loosening of said cable.

29. The method of claim 28, wherein steps for unlocking said internal portal covering comprises sending signals from said wireless communication device to said valve to retract said retractable bolt, thereby disconnecting said cable from said retractable bolt.

30. The method of claim 23, wherein said latching mechanism comprises a fluid-operable piston mechanism, further comprising connecting first and second tubes between a valve and said fluid-operable piston mechanism, said first tube being adapted to transport a fluid at a first pressure to said fluid-operable piston mechanism from said valve and said second tube being adapted to transport a fluid at a second pressure from said fluid-operable piston mechanism to said valve, said first pressure being greater than said second pressure.

31. The method of claim 30, wherein said fluid transported in said first tube activates said fluid-operable piston mechanism and provides a pulling force on said spring, said pulling force being translated to said latch to retract said bolt from said portal covering.

32. The method of claim 31, wherein said fluid transported in said second tube deactivates said fluid-operable piston mechanism and releases the pulling force on said spring, thereby allowing said bolt to extend into said portal covering.

33. The method of claim 30, wherein said wireless communication device transmits first signals to said valve to allow fluid from a fluid source to be transported through said first tube to said fluid-operable piston mechanism and transmits second signals to said valve to allow fluid from said fluid-operable piston mechanism to be transported through said second tube to the fluid source.
